(19) United States
(12) Patent Application Publication
(10) Pub. No.: US 2021/0100263 A1
(43) Pub. Date: Apr. 8, 2021

(54) Process for the Manufacture of a Textured Protein Foodstuff

(71) Applicant: ProForm Innovation Pty Limited, Mount Kuring-gai (AU)

(72) Inventor: Charlie Chessari, Mount Kuring-Gai (AU)

(21) Appl. No.: 17/044,644

(22) PCT Filed: Apr. 4, 2019
(86) PCT No.: PCT/AU2019/050293

§ 371 Date: Oct. 1, 2020

(30) Foreign Application Priority Data
Apr. 4, 2018 (AU) 2018901108

(51) Int. Cl. A23J 3/26; A23J 3/22; A23J 3/16; A23J 3/04; A23P 30/20

(52) U.S. Cl. CPC A23J 3/26; A23J 3/227; A23P 30/20; A23J 3/04; A23J 3/16

(57) ABSTRACT

A high-throughput continuous extrusion process for the manufacture of a textured protein foodstuff having organoleptic qualities comparable to cooked muscle meat.

### TECHNICAL FIELD

The invention relates to the field of commercial extruded food manufacture. In particular, the invention relates to a process for producing an extruded high moisture texturised protein food product at a relatively high throughput rate.

### BACKGROUND OF THE INVENTION

By 2050 the world's population is projected to reach 9 billion and it has been suggested that 70% more food will be required to sustain this population. Between 1950 and 2000 meat production increased from 45 to 229 million tons and this is expected to further increase to 465 million tons by 2050.

The relatively inefficient conversion of plant protein into animal protein via animal metabolism makes meat production responsible for a disproportionate share of environmental pressures such as land use, freshwater depletion, global warming and biodiversity loss.

A solution to reduce the impact of meat production on the environment is offered by partial replacement of meat protein with plant protein products in the human diet. However, there is a desire that these protein products have favourable organoleptic properties, such as flavour and texture, when compared with meat.

Both the food industry and food scientists have been interested in creating fibrous food textures for several decades now. High Moisture Extrusion Cooking (HMEC) technology as a concept has been established since the early 1980's. It is a technology for texturising protein-rich materials under high moisture content conditions of greater than 40% by mass.

In a typical HMEC process according to the prior art, the raw materials are heated under pressure in an extrusion cooker until molten; the resulting melt then been cooled and solidified in-situ by a cooling die to produce aligned protein fibres from the melt, giving a product with a meaty texture that satisfies organoleptic requirements.

Accordingly, it is an object of the invention to provide a HMEC technology that ameliorates at least some of the problems associated with the prior art.

### SUMMARY OF THE INVENTION

The invention is characterised by a novel process for high moisture continuous cooking technology that facilitates the fibrous restructuring of vegetable or ‘flexitarian’ proteinaceous material (utilising animal and plant protein). The invention provides, via a combination of raw material formulation and equipment design and configuration, high quality HMEC products with aesthetically desirable fibrous texture at production rates that are commercially attractive.

According to a first aspect of the invention, there is provided a high-throughput continuous extrusion process for the manufacture of a textured high-moisture protein foodstuff having organoleptic qualities comparable to cooked muscle meat, said process including the steps of: preparing a blend of dry proteinaceous materials, including soy protein and/or gluten; then feeding said blend into a feed port of an extrusion cooker, in conjunction with water, in a ratio of between 18%-53% dry proteinaceous materials to between 6%-70% water, wherein said combination has a protein content of greater than 15% and a fat content of less than 10%; wherein said extrusion cooker is a twin-screw co-rotating type with a heated barrel and a feed port for receiving said blend and water; then continuously transferring the output of said extrusion cooker to a cooling die that is adapted to cool the extrudate such that a fibrous internal alignment of proteins forms in the extrudate; then transferring the cooled extrudate to a mechanical size reduction device adapted to tenderise and shred the extrudate in to pieces of a consistent size distribution.

Alternatively, the blend of material fed into the extrusion cooker further includes up to 70% wet proteinaceous material such as ground meat, offal or the like.

The texturised protein products produced via this process have a very realistic ‘meat-like’ internal fibrous structure and texture. Whilst fibrous textures for such products have been achieved in the prior art, none have yet been achieved at the commercial production rates that have been achieved via the present invention.

In addition, the inventive process allows this texture to be achieved without the addition of animal-derived protein, e.g. a ‘flexitarian’ format where plant protein alone or in combination with animal protein can be successfully utilised, which is a clear advance versus the prior art where ‘vegetarian’ formulations have not been able to produce as realistic an appearance or texture.

Preferably, the screw profile of said extrusion cooker includes approximately: 42% conveying elements, 42% CSTR mixing elements and approximately 16% high pressure pumping elements. This has been found by the inventors to produce a more desirable product.

Preferably, the temperature profile applied to the barrel of the extrusion cooker is approximately: 95-105° C. at 37.5% of the barrel length from the feed point; 95-125° C. at 62.5% of the barrel length from the feed point; 110-135° C. at 80% of the barrel length from the feed point; 115-135° C. at 95% of the barrel length from the feed point; and 115-125° C. at 100% of the barrel length from the feed point. This has been found by the inventors to produce a more desirable product.

Preferably, the cooling die is a counter-current crossflow heat exchanger adapted to provide a relationship between residence time (RT) in the die and the characteristic dimension relating to the thickness of internal extrudate channel (d) according to the following: RT=11.7 d^{0.7}. This has been found by the inventors to produce a more desirable product.

Preferably, the feed port of the extrusion cooker is configured such that at least part of the proteinaceous material and water enter the extrusion cooker in the same position relative to the length of the extruder barrel, but also such that said proteinaceous material and water enter the extrusion cooker in a position offset from the centreline in such a way as to be moved immediately downstream of the water by the screw flights. This has been found by the inventors to produce a more desirable product.

According to another aspect of the invention, there is provided an extrusion cooker adapted to carry out the process as defined above.

According to another aspect of the invention, there is provided a cooling die adapted to carry out the process as defined above.

According to another aspect of the invention, there is provided a feed port for an extrusion cooker adapted to carry out the process as defined above.

According to another aspect of the invention, there is provided a textured protein foodstuff having organoleptic qualities comparable to cooked muscle meat manufactured by a process as described above.

Now will be described, by way of a specific, non-limiting example, a preferred embodiment of the invention with reference to the drawings.

### BRIEF DESCRIPTION OF THE DRAWINGS

FIG. 1 is a schematic diagram illustrating a process according to the invention.

FIGS. 2A, 2B and 2C is a flowchart representing a process according to the invention.

FIG. 3 is a representation of a feed-port to an extrusion cooker adapted to facilitate the process according to the invention.

FIG. 4 is a photograph of product resulting from a process according to the invention.

### DETAILED DESCRIPTION OF THE INVENTION

The invention may be embodied as a commercial scale process for the manufacture of a texturised protein product that has meat-like fibres in a highly integrated, robust and stable configuration.

The invention represents a unique high-throughput continuous production system that is capable of generating a succulent, vegetarian or flexitarian protein product format at relatively low temperature and pressure. By ‘high-throughput’ is meant an increase of greater than 30% throughput compared with using an extrusion system of similar size under conventional processing approaches.

The process according to the invention allows transformation of blends of vegetable and animal proteins through an integrated cooking and cooling process that produces a fibrous texture, representing a homogeneous mixture of meat and plant protein. Particularly, it provides a method for taking an untextured, paste-like, batter-like protein product with no visible grain or texture and converting it into a texturised, fibrous protein product having the consistency of cooked muscle meat.

The core transformational step in the process is the cooking extruder. The raw materials are heated in the main extruder barrel until molten. The resulting melt is cooled via a continuous throughput cooling die after exiting the extruder to produce fibres from the melt, resulting in a final product with a chewy texture characteristic of meat.

In this context, the food extruder can be regarded as a high temperature-short time (HTST) bioreactor that can process a variety of raw ingredients into finished food products, introduce desirable functional properties into food ingredients, and destroy or inactivate undesirable components of food materials.

Extrusion cooking with food mixes of 40 to 80% moisture reduce or prevent viscous dissipation of energy and product expansion, but facilitate operations such as fat emulsification, protein gelation, restructuring, and shaping and/or fibrillation of specific protein constituents.

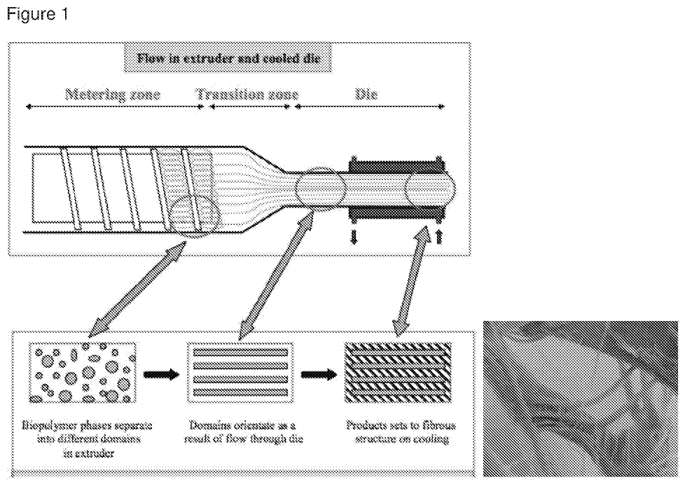

FIG. 1 schematically illustrates the lamination process. In the metering zone in the extruder screws, biopolymer phases in the protein separate into different domains. In the transition zone, usually a transition channel that is internally shaped to promote laminar flow of the molten protein, the separated domains are oriented in laminar striations. As these striations pass through the cooling die, the protein striations cool and are set into these laminar orientations. These can then be shredded and resemble cooked muscle fibre.

The process according to the invention begins with the formulation of recipes comprising appropriate animal and/or plant proteins. These recipes are formulated to establish the required rheological consistency that facilitates stable delivery to the cooker.

The delivery of the raw material formulation is partitioned such that stability in the cooker is enhanced. The partitioning of multiple feed streams based on rheological requirements establishes a process that can effectively manage the melt rheology within the cooker in a robust and stable manner.

The internal profiling of the heat treatment and residence time within the cooker (via the extruder screw configuration) is developed to facilitate throughput efficiency, melt formation and plasticisation. The screw profile within the cooker is specified to develop proper channel filling and a progressive build-up of pressure in the extruder as the melt progresses through the extruder.

The pumping effect of a cooker with intermeshing and co-rotating screws requires a sufficiently viscous melt. The melt viscosity depends primarily on the temperature and the water content of the extrudate, but the type of food constituents (including water-binding polysaccharides) and their response to the thermochemical process also affects viscosity.

The successful preparation of HMEC products requires the selection and control of extrusion variables that are highly dependent on the composition of the feed material. The transitioning of the melt state to the solidification state in a continuous fashion is critical to develop texture at high throughputs.

This equipment used in the inventive process is designed to achieve this without the use of a breaker plate. A breaker plate with several holes 1 or 2 mm in diameter located before the die is typically used in encouraging a homogenous distribution of pressure and food material across the die section, and initiate stream alignment of protein aggregates.

The dimensions of the dies, the degree of polish of metal surfaces, the insertion of breaker plates, and other characteristics are required to be matched to the melt rheology. However, such arrangements are susceptible to blockage and are unnecessary in the integrated process according to the invention. The invention allows the food manufacturer to avoid the use of breaker plates and the disadvantages associated with them such as blockages that can be disruptive and costly in a commercial operation.

The lamination of the melt occurs in the cooling die. This is attached to the outlet of the extrusion cooker and is where the external profile shape of the product is established (corresponding to the cross-section of the cooling die).

The cooling die is effectively a heat exchanger that enables a progressive rate of solidification of the melt, which in turn generates a laminated fibrous structure. The cooling die itself is a tubular steel conduit that defines the channel through which the product progresses, surrounded by a liquid-cooled jacket that progressively removes heat from the product, beginning as a molten liquid and exiting the cooling die as a solid product with an internal ‘fibrous’ texture.

The design and operation of the cooling die is optimized to maximise the throughput of raw materials, as this step has been found to be a rate-limiting step in prior art processes.

Within the cooling die, the food product in direct contact with the cooled metal conduit surface becomes thicker, tends to stick to the surface, and moves at a lower speed than internal zones of still-molten product. Velocity gradients and shear forces develop mainly in the peripheral zones of the product, causing a shear alignment of the unfolded protein macromolecules, or of dispersed particles, and the formation of parallel layers of relatively great protein length.

These rheological phenomena require lamellar flow of the melt. Therefore, there must be equilibrium between the viscosity of the product at cooling temperatures and the flow velocity itself a function of the product through the die. The interplay between the increase of viscosity, as the melt is cooled, and the shear induced flow velocity must be balanced so as not to induce disruptive flow as solidification occurs as the macromolecular alignment is otherwise catastrophically disrupted. It is not effective to cool down the extrudate too soon in the process, otherwise the molecules will not have time to re-orientate and elongate with the shear impacted flow direction of the extrudate. Proteins processed and formed in this manner will not tend to align in the direction of extrusion.

Both the decrease in temperature and the macromolecular alignment may enhance the formation of protein-protein bonds, possibly with a regular, almost crystalline aggregation leading to parallel fibres of varying length and thickness. The internal dimensions of the die conduit and the frictional properties of the internal surfaces of the conduit influence the quality of the final product.

The product then proceeds to an in-line cutting system that undertakes initial size reduction while the material is at an elevated temperature, and therefore still malleable.

Subsequent geometry randomisation to enhance the product's ‘meaty’ appearance texture may then be undertaken; followed optionally by in-line continuous marination that enhances flavour.

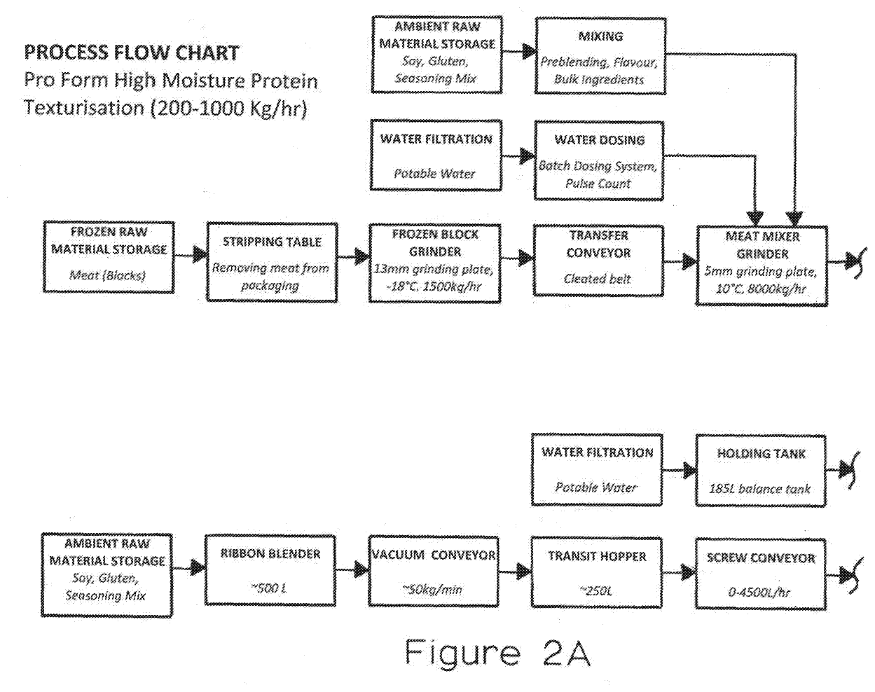

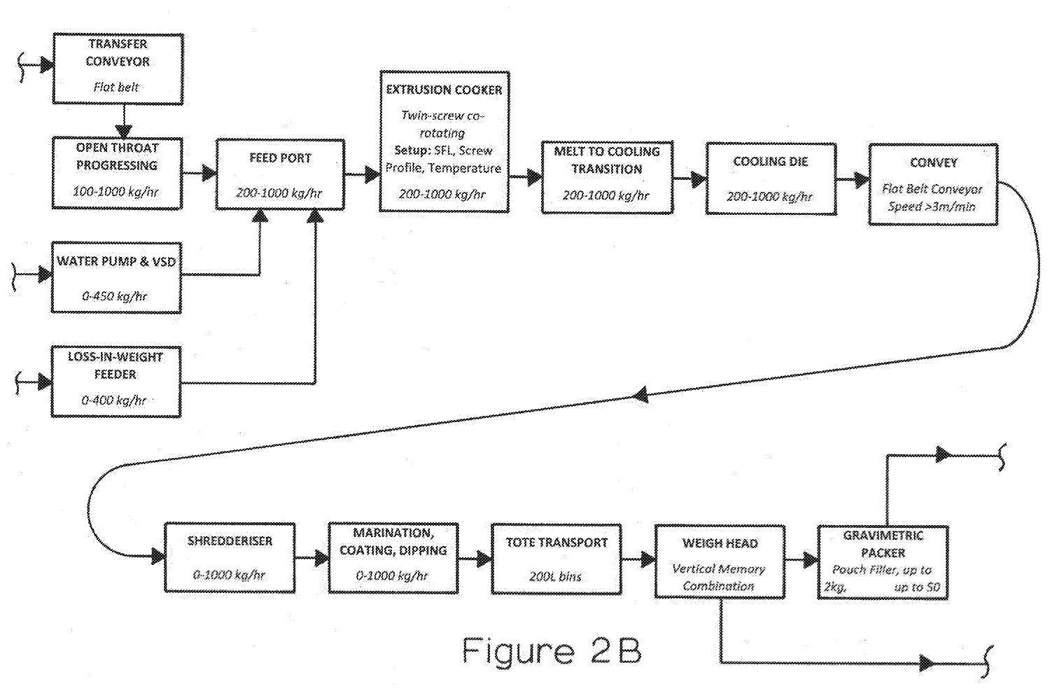

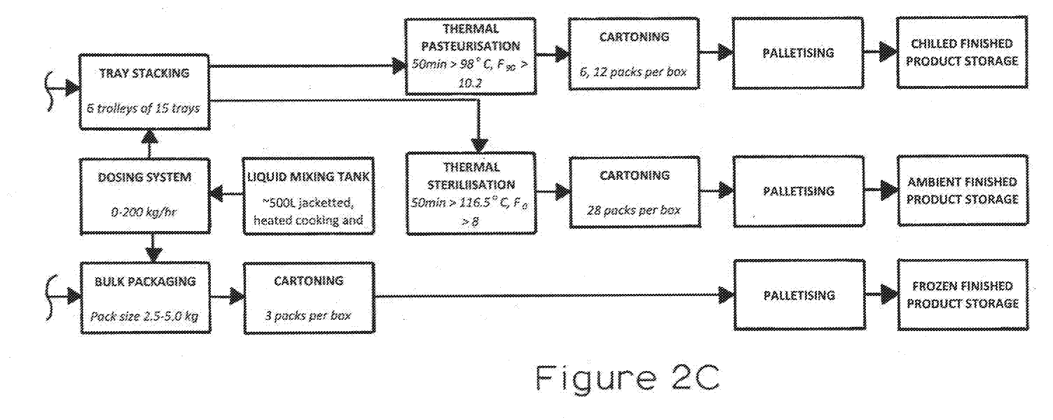

Example: The flowchart in FIG. 2 represents an embodiment of a process according to the invention. This process is a ‘pilot scale’ version of the process, capable of delivering output of high-moisture extruded product with a particular internal texture at between 200-1000 kg/hr. This process, as illustrated in this particular example, is nevertheless readily capable of being scaled up to produce said product of the same quality at rates of up to at least 1938 kg/hr.

The process according to this embodiment may be summarised as the combining of raw materials (including cereals, meat, water and seasoning) in an extrusion cooker, wherein the materials are processed under elevated temperature and pressure into a molten liquid. The molten liquid is subsequently transferred to a water-cooled cooling die, wherein the liquid is caused to form a fibrous internal texture. Upon emerging from the cooling die as a solid mass, the product is subjected to size-reduction steps and optionally to flavour-development steps before being sterilised and packed.

The feed materials are prepared according to their kind. If the formulation requires, meat is supplied in frozen blocks (approx. −18° C.) that are stripped and ground though a 13 mm hole plate and transferred to a mixing grinder with a 5 mm hole plate. Here it is combined with a first portion of water and a premixed blend of soy protein, gluten and flavourings/seasonings and ground at approximately 10° C. This mixture is transferred to an open throat progressing cavity of the extrusion cooker.

A second blend of soy protein, gluten and flavourings/seasonings is also prepared in a ribbon blender and transferred via a vacuum conveyer to a loss-in-weight feeder that meters the blend into a second feed-port in the extrusion cooker, in parallel with a second portion of water.

The extrusion cooked in this example is a twin-screw co-rotating extruder with a steam-heated barrel, as supplied by Clextral, model BC72. The extrusion cooker screw profile is designed for optimised performance for texturization, based on increasing the residence time along the sections and enhancing specific mechanical energy input. In this embodiment, the screw profile comprises, from feed to discharge: 42% conveying elements, 42% CSTR (continuous stirred tank reactor) type mixing elements, and 16% high pressure pumping element which those experienced and skilled in the art of developing screw profiles may adjust to achieve desired properties.

The feed of raw materials into the extrusion cooker is governed according to a relationship between the mass feed rate and the screw speed, which allows scalability of the process to extrusion cookers of different diameters. Specific Feed Loading (SFL) is the term used for this relationship:
Specific Feed Loading is defined as follows:

$$SFL = \frac{Feed Rate ( kg \text{/} hr )}{Screw Speed ( RPM )}$$

In general, the scaleup equation is s follows:

$$( \frac{S F {L}_{{scale }_{1}}}{S F {L}_{{scale}_{2}}} ) = {( \frac{{d}_{{scale}_{1}}}{{d}_{{scale}_{2}}} )}^{3}$$

For example, for 76 mm diameter extrusion cooker, SFL scaleup operating range is 0.8-1.0.

The second feed port is designed in a way to utilise the screw diameter, the centre line distance, the width of the barrel and the scale independent rate of entry of the raw materials to derive placement positions of premixed wet proteinaceous raw materials and water ports via a parametric predictive model, i.e. whereby entry velocities of the proteinaceous and water streams are combined with parametric scaleup data that has been developed via experimental observations of the inventors.

Accordingly, the implementation is manifested in a singular feed port constructed from appropriate plastic material. The meat premix has a conical pressurisation reducer of ratio 1.9:1 to ensure steady flow into the cooker.

This means that the second feed port of the extrusion cooker is configured such that at least part of the proteinaceous material and water enter the extrusion cooker via said port at the same point relative to the length of the extruder barrel, but also such that said proteinaceous material and water enter the extrusion cooker in a position offset from the centreline in such a way as to be moved immediately downstream of the water by the screw flights.

It is also preferred that the proteinaceous material is deposited straight on to the screw: that is: delivered immediately above the screw flights so there is a positive pressure exerted on the material at the delivery point. This facilitates the immediate engagement and mixing of the material mix in the screw flights, particularly to avoid stratification or slugs in the material.

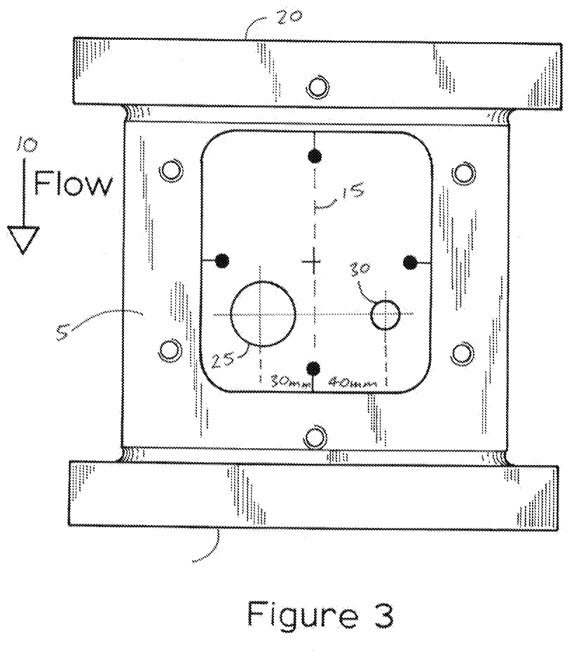

In this example, with reference to FIG. 3, a plan view is shown of a second feed port 5 as installed on the extrusion cooker, wherein the flow of the materials in said cooker are indicated by the (downward) arrow 10 on the left-hand side of the diagram, and where the centre-line 15 of said feed port 5 is coplanar with the centre of the extrusion cooker barrel (not shown). The port, in this example, has a length of 144 mm and a width of 133 mm, to illustrate relative size.

The aforementioned second blend of dry premixed cereal and seasoning is introduced to the left-side screw at a point 100 mm from the ‘feed’ end of the port 20 and 30 mm to the left of the centreline 15, in an area represented by the large circle 25, while the water feed is introduced to the right-side screw at a point 100 mm from the ‘feed’ end of the port and 40 mm to the right of the centreline, in a zone represented by the smaller circle 30.

The precise dimensions used for this particular feed port and feed locations described above are used only as an example. They can be linearly scaled to adapt to a variety of different extruder barrel sizes. In general, it can be expressed that the solid materials are added to the feed port at a point distant from the centre of the barrel that is 0.3 times its distance from the feed end of he port, and that the water is added to the feed port at a point distant from the centre of the barrel that is 0.4 times its distance from the feed end of the port.

The sizing and orientation of these feed points generated by this feed port design protocol facilitates seamless introduction and mixing in-situ of said dry and wet materials immediately upon introduction to the extruder. This enhances mixing and allows greater machine throughputs to be achieved. This is because the motion of the twin screws will move and combine these streams together in an optimal manner. In addition, without such a configuration, there is a tendency for the material not to be transported away efficiently from the feed port, thereby risking non-facilitation of stable processing in the extruder barrel.

The temperature profile in the extrusion cooker barrel is based on temperatures achieved at five points along the barrel length from the feed point to the discharge point. In this embodiment the temperature profile positions are as follows in Table 1:

TABLE 1

| | Proportional Distance from | Target |
|---|---|---|
| | Extrusion Cooker Barrel Feed | Temperature Range |
| Point | to Discharge (%) | (° C.) |
| 1 | 37.5 | 95-105 |
| 2 | 62.5 | 95-125 |
| 3 | 80 | 110-135 |
| 4 | 95 | 115-130 |
| 5 | 100 | 115-125 |

The profiles are adjusted in the above ranges to achieve particular textural profiles. The extruder barrel temperature has an important effect on extrudate characteristics. If the barrel temperature is too low, the feed material will not undergo the necessary molecular transformations (denaturation, protein cleavage and the formation of covalent bonds) to give characteristics typical of the extruded products. A softer product will result. As the barrel temperature increases so does product strength.

However, other effects on the product limit maximum barrel temperature. At too high a temperature, e.g. above 175° C., there is a sharp decrease in the extrudate hardness, due to the fact that disulphide bond strength decreases as temperature increases. In addition, the melt tends to burn on to the extruder barrel. This results in the appearance of unsightly black or dark brown pieces in the finished products, as the melt “burns on” to the extruder barrel wall: periodically a piece of this burnt-on material falls off the extruder wall and is carried through in the product.

It is also well known that optimal temperature conditions vary with botanical source of protein as the proportions of different types of proteins present in the feed material can have a complex effect on the textural characteristics of products. Different proteins have different gel forming properties due to factors such as amino acid composition, molecular weight and thermal stability.

The extruder barrel temperature controllers are preferably adapted to function as manipulated variable slave controllers to achieve the output target profile of the melt temperatures. The melt temperature profiles allow rheological management of texturisation and are scalable, irrespective of throughput rate changes on an existing extrusion cooker, or on an extrusion cooker of different dimension or design, e.g. from a different manufacturer.

The molten mixture then exits the extrusion cooker barrel and passes through a transition piece into the cooling die. The cooling die may be set up as a cross-flow heat exchanger, having a hollow stainless steel conduit through which the product flows as it is cooled, and a surrounding jacket through which water is pumped to as a coolant to remove heat from the product.

It is particularly desirable that, while the molten product is liquid, it maintains laminar (not turbulent) flow as it passes into and through the cooling die.

To achieve this at different cooling die flow rates and capacities, the Cooling Die Heat Transfer Parametric Model was developed. This is derived form a calculation based on thickness of product conduit (and therefore product), desired residence time, and unsteady state heat transfer dimensionless numbers—Fourier and Biot numbers. This can be expressed as:

RT=11.7 d^{0.7}

Where RT=residence time in the cooling die to achieve the target output temperature in seconds; and d=characteristic dimension of the cooling die shape in millimetres. For a cylindrical cooling die the characteristic dimension is the radius of the cooling die channel, and for a rectangular ‘slab’ cooling die the characteristic dimension is half the thickness of the rectangular cooling die channel.

The residence time and conduit size relationships thereby determine a cooling maximum rate and throughput which is scale independent.

For a rectangular cooling die conduit with a cross sectional area of 2900 mm² and a thickness of 20 mm, a 4 m long cooling die is predicted to have a maximum throughput rate of 420 kg/hr, which has been measured and validated.

For such a rectangular conduit cooling die configuration the die would be set up as a counter-current crossflow heat exchanger. The crossflow heat exchanger external jacket geometry includes baffles placed at a 40% spacing along the coolant flow channel with a baffle cut of 14%, resulting in a flow velocity of 1 to 7 m/s of cooling water, utilising a water flow depth of 14 mm. The surface finish is preferred as Ra<=0.3 μm. This is equivalent to a Surface Finish #7 (Mechanical Buffing on #4 and 320 Final Polish Grit Size) as per Table 2.

TABLE 2
STAINLESS STEEL FINISHES

| Surface | Metal Working | Final Polish | Ra | RMS |
|---|---|---|---|---|
| Finish # | Methods | Grit Size | Microinch | Microinch |
| 1 | Hot roll, anneal | Unpolished | 500 | N/a |
| | and descale | | | |
| 2D | Cold roll, anneal | Unpolished | 125 | N/a |
| | and descale | | | |
| 2B | Cold roll, anneal | Unpolished | 80 | N/a |
| | descale and final light | | | |
| | cold roll with polished | | | |
| | rolls | | | |
| 3 | Mechanical polishing | 100 | 60 | 67 |
| | on #1, 2D, or 2B | | | |
| 3 | Mechanical polishing | 120 | 52 | 58 |
| | on #1, 2D, or 2B | | | |
| 4 | Mechanical polishing | 150 | 42 | 47 |
| standard | on 2B or 2D | | | |
| sanitary | | | | |
| 4 | Mechanical polishing | 180 | 30 | 34 |
| high grade | on 2B or 2D | | | |
| sanitary | | | | |
| 4 | Mechanical polishing | 240 | 15 | 17 |
| ultra high | on 2B or 2D | | | |
| sanitary | | | | |
| 7 | Mechanical buffing | 320 | 12 | 14 |
| | on #4 | | | |
| 8 | Mechanical buffing | 400 | 5 | 7 |
| | on #4 | | | |

After exiting the cooling die, the product can undergo size-reduction and flavour addition or flavour development steps and packing/storage.

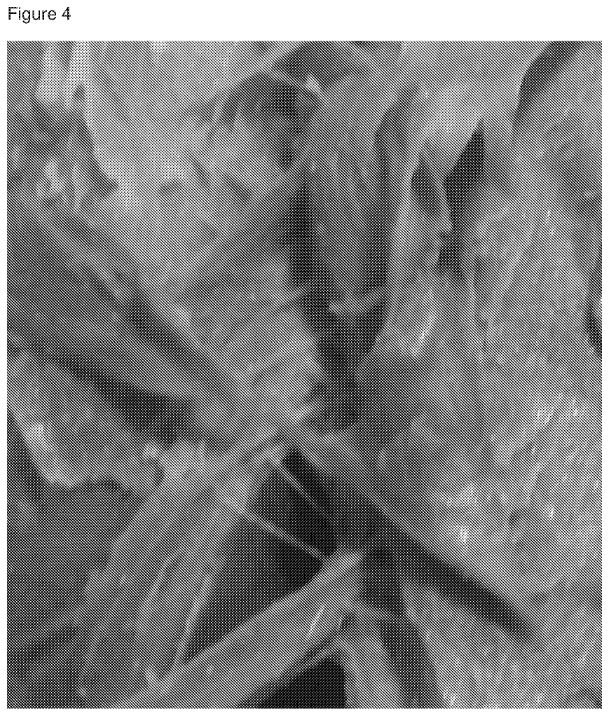

FIG. 4 shows the internal texturisation after shredding of the product according to the above example. It will be noted that it has a fibrous, striated internal texture which resembles animal protein-derived meats.

It will be appreciated by those skilled in the art that the above described embodiment is merely one example of how the inventive concept can be implemented. It will be understood that other embodiments may be conceived that, while differing in their detail, nevertheless fall within the same inventive concept and represent the same invention.

1. A high-throughput continuous extrusion process for the manufacture of a fibrous-textured high-moisture protein foodstuff having organoleptic qualities comparable to cooked muscle meat, said process including the steps of:
preparing a blend of dry proteinaceous materials and/or a stream of wet protein material;
then feeding said blend into a feed port of an extrusion cooker, in conjunction with water, in a ratio of between 18%-53% dry proteinaceous materials to between 6%-70% water, wherein said combination has a protein content of greater than 15% and a fat content of less than 10%;
wherein said extrusion cooker is preferably a twin-screw co-rotating type with a heated barrel and a feed port adapted to receive said blend and water; and
wherein the feed port of the extrusion cooker is configured such that at least part of the proteinaceous material and water enter the extrusion cooker in the same position relative to the length of the extruder barrel, but also such that said proteinaceous material and water enter the extrusion cooker in a position offset from the centreline in such a way as to be moved immediately downstream of the water by the screw flights;
then continuously transferring the output of said extrusion cooker to a cooling die that is adapted to cool the extrudate such that a fibrous internal alignment of proteins forms in the extrudate;
then transferring the cooled extrudate to a mechanical size reduction device adapted to tenderise and shred the extrudate in to pieces of a consistent size distribution.

2. The process of claim 1, wherein the solid materials are added to the feed port at a point distant from the centre of the extruder barrel that is 0.3 times its distance from the feed end of the port, and the water is added to the feed port at a point distant from the centre of the barrel that is 0.4 times its distance from the feed end of the port.

3. The process of claim 1, wherein the material fed into the extrusion cooker further includes up to 70% wet proteinaceous material such as ground meat, offal or the like.

4. The process of claim 1 wherein the screw profile of said extrusion cooker includes approximately: 42% conveying elements, 42% CSTR mixing elements and approximately 16% high pressure pumping elements.

5. The process of any preceding claim wherein the temperature profile applied to the barrel of the extrusion cooker is approximately: 95-105° C. at 37.5% of the barrel length from the feed point; 95-125° C. at 62.5% of the barrel length from the feed point; 110-135° C. at 80% of the barrel length from the feed point; 115-135° C. at 95% of the barrel length from the feed point; and 115-125° C. at 100% of the barrel length from the feed point.

6. The process of any preceding claim, wherein the cooling die is adapted to provide a relationship between residence time (RT) in the die and the characteristic dimension of the internal extrudate channel (d) according to the following relationship: RT=11.7 d^{0.7}.

7. An extrusion cooker adapted to carry out the process as defined in any preceding claim.

8. A cooling die adapted to carry out the process as defined in claim 6.

9. A feed port for an extrusion cooker adapted to carry out the process as defined in claim 1.

10. A fibrous-textured protein foodstuff having organoleptic qualities comparable to cooked muscle meat manufactured by a process according to any one of claims 1 to 6.
